(19) United States
(12) Patent Application Publication
(10) Pub. No.: US 2023/0140068 A1
(43) Pub. Date: May 4, 2023

(54) POLYESTER ELASTOMER RESIN COMPOSITION

(71) Applicant: TOYOBO CO., LTD., Osaka (JP)

(72) Inventors: Yuki TAMASHIRO, Shiga (JP); Junichi NAKAO, Shiga (JP)

(73) Assignee: TOYOBO CO., LTD., Osaka (JP)

(21) Appl. No.: 17/801,645

(22) PCT Filed: Feb. 24, 2021
(86) PCT No.: PCT/JP2021/006843

§ 371 Date: Aug. 23, 2022

(30) Foreign Application Priority Data
Feb. 26, 2020 (JP) 2020-030296

(51) Int. Cl. C08G 63/183; C08G 64/02; C08K 5/5313; C08K 5/1515; C08K 5/20

(52) U.S. Cl. CPC C08G 63/183; C08G 64/02; C08K 5/5313; C08K 5/1515; C08K 5/20; C08K 2201/005

(57) ABSTRACT

The present invention is a polyester elastomer resin composition that has excellent extrusion moldability and surface smoothness even in a thin shape, while maintaining mechanical characteristics, and that is halogen-free and has excellent flame retardancy as well as heat aging resistance and hydrolysis resistance. The polyester elastomer resin composition comprises a polyester elastomer (A) and a phosphorus flame retardant (B); the polyester elastomer (A) comprises a hard segment composed of a polyester and at least one soft segment selected from aliphatic polyethers, aliphatic polyesters, and aliphatic polycarbonates, and has a Shore D surface hardness of 55 or less; the phosphorus flame retardant (B) has an average particle size D50 of 20 μm or less and a phosphorus concentration of 15 mass % or more; and the polyester elastomer resin composition comprises 5 to 50 parts by mass of the phosphorus flame retardant (B) and optionally a predetermined amount of an acid end capping agent (C) based on 100 parts by mass of the polyester elastomer (A), and has an acid value of 10 eq/ton or less.

### TECHNICAL FIELD

The present invention relates to a polyester elastomer composition that has excellent extrusion moldability and surface smoothness even in a thin shape, while maintaining mechanical characteristics, and that is halogen-free and has excellent flame retardancy as well as heat aging resistance and hydrolysis resistance.

### BACKGROUND ART

In recent years, the replacement of metal and rubber parts with thermoplastic resins has been promoted in automobiles and home electrical appliances parts. Further, as the performance of automobiles and home electrical appliances increases, the distance between parts is decreasing, and there are increasing opportunities for resin parts to be exposed to higher temperatures than before. From these development trends, it is strongly desired to develop resin compositions having both heat resistance and flame retardancy.

In response to these demands, thermoplastic polyester elastomers, such as polyether ester elastomers, polyester ester elastomers, and polycarbonate ester elastomers, are known to have excellent heat aging resistance and mechanical characteristics.

Mixing halogen-based flame retardants is known to be the most popular method for improving the flame retardancy of thermoplastic resins, including thermoplastic polyester elastomers. However, such thermoplastic polyester elastomers using halogen compounds generate toxic gas during combustion, so that the use of halogen compounds has been limited from the viewpoint of environmental protection in recent years. Therefore, it is considered ideal to improve the flame retardancy of thermoplastic polyester elastomers without using halogen-based flame retardants.

In order to meet these demands, in a recently proposed method, a specific metal hydrate is mixed as an inorganic flame retardant, which can suppress the combustion of resin by causing decomposition and dehydration reactions by an endothermic reaction at the combustion temperature of the resin. However, since the metal hydrate used in this method is much less effective to impart flame retardancy, it is necessary to add a large amount of the metal hydrate to achieve a flame-retardant effect. As a result, there arises a problem that the forming processability of the resulting flame-retardant resin composition is lowered and the mechanical strength of the resulting molded article is also lowered.

Accordingly, in recent years, in order to meet the above demands, methods using the following specific phosphorus compounds have been proposed: a fire prevention material that combines ethylenediamine phosphate with melamine and/or a salt of a cyanuric acid derivative, such as melamine phosphate (PTL 1); and a flame-retardant thermoplastic resin composition comprising phosphate, such as alkyl diamine phosphate, as a flame retardant (PTL 2).

Also disclosed is an intumescent flame retardant that forms a surface expansion layer (intumescent) during combustion and exhibits flame retardancy by suppressing the diffusion and heat transfer of decomposition products (PTL 3). However, even these phosphorus flame retardants are less effective to impart flame retardancy compared with halogen-based flame retardants, and a large amount of addition is required. The fact is that polyester elastomers are not yet sufficient in terms of achieving high flame retardancy and other characteristics (mechanical characteristics, as well as heat aging resistance and hydrolysis resistance).

Furthermore, in tube and electric wire covering applications that must be extruded, the addition of a large amount of flame retardant sometimes causes a problem that the appearance of molded articles deteriorates. There is another problem from the viewpoint of compatibility with product quality.

### CITATION LIST

### Patent Literature

PTL 1: JPS50-107044A
PTL 2: JPS50-109946A
PTL 3: JPS59-47285A

### SUMMARY OF INVENTION

### Technical Problem

The present invention was made in view of the current state of the prior art. An object thereof is to provide a flame-retardant polyester elastomer composition that has excellent extrusion moldability and surface smoothness even in a thin shape, while maintaining mechanical characteristics, and that is halogen-free and has excellent flame retardancy as well as heat aging resistance and hydrolysis resistance.

### Solution to Problem

As a result of intensive research on flame-retardant polyester elastomer compositions without using halogen compounds to achieve the above object, the present inventors have finally completed the present invention.

Specifically, the present invention is as described below.

[1] A polyester elastomer resin composition comprising a polyester elastomer (A) and a phosphorus flame retardant (B);

the polyester elastomer (A) comprising a hard segment and a soft segment and having a Shore D surface hardness of 55 or less, wherein the hard segment is composed of a polyester comprising an aromatic dicarboxylic acid and an aliphatic or alicyclic diol as constituents, and the soft segment is at least one member selected from aliphatic polyethers, aliphatic polyesters, and aliphatic polycarbonates;

the phosphorus flame retardant (B) having an average particle size D50 of 20 μm or less and a phosphorus concentration of 15 mass % or more; and

the polyester elastomer resin composition comprising 5 to 50 parts by mass of the phosphorus flame retardant (B) and further, as an acid end capping agent (C), 0 to 5 parts by mass of an epoxy compound (C-1) or 0 to 1.5 parts by mass of a carbodiimide compound (C-2), based on 100 parts by mass of the polyester elastomer (A), and having an acid value of 10 eq/ton or less.

[2] The polyester elastomer resin composition according to [1], wherein the hard segment of the polyester elastomer (A) is a polyester comprising terephthalic acid and 1,4-butanediol as constituents, the soft segment is an aliphatic polycarbonate diol, and the polyester elastomer (A) has a melting point of 150 to 230° C.

[3] The polyester elastomer resin composition according to [1] or [2], wherein the phosphorus flame retardant (B) is a phosphinic acid metal salt, (poly)phosphate, or both of them.

[4] The polyester elastomer resin composition according to any one of [1] to [3], further comprising 0.1 to 3 parts by mass of an amide lubricant (D) based on 100 parts by mass of the polyester elastomer (A).

[5] The polyester elastomer resin composition according to any one of [1] to [4], for use in cable covering.

### Advantageous Effects of Invention

The flame-retardant polyester elastomer resin composition of the present invention has excellent extrusion moldability and surface smoothness even in a thin shape, while maintaining mechanical characteristics, and is halogen-free and can satisfy both excellent flame retardancy as well as heat aging resistance and hydrolysis resistance.

### DESCRIPTION OF EMBODIMENTS

### Polyester Elastomer (A)

The polyester elastomer (A) used in the present invention comprises a hard segment and a soft segment. The hard segment is composed of a polyester. The aromatic dicarboxylic acid constituting the polyester of the hard segment can be any of a wide range of general aromatic dicarboxylic acids, and is not particularly limited; however, the main aromatic dicarboxylic acid is desirably terephthalic acid or naphthalenedicarboxylic acid (among isomers, 2,6-naphthalenedicarboxylic acid is preferred). The content of terephthalic acid or naphthalenedicarboxylic acid is preferably 70 mol % or more, and more preferably 80 mol % or more, in the total dicarboxylic acids constituting the polyester of the hard segment. Other dicarboxylic acid components are, for example, aromatic dicarboxylic acids, such as diphenyldicarboxylic acid, isophthalic acid, and 5-sodium sulfoisophthalic acid; alicyclic dicarboxylic acids, such as cyclohexanedicarboxylic acid and tetrahydrophthalic anhydride; and aliphatic dicarboxylic acids, such as succinic acid, glutaric acid, adipic acid, azelaic acid, sebacic acid, dodecanedioic acid, dimer acid, and hydrogenated dimer acid. These are used within a range that does not significantly reduce the melting point of the resin, and the amount thereof is preferably 30 mol % or less, and more preferably 20 mol % or less, of the total acid components.

Further, in the polyester elastomer (A) used in the present invention, the aliphatic or alicyclic diol constituting the polyester of the hard segment can be any of a wide range of general aliphatic or alicyclic diols, and is not particularly limited; however, it is desirable to mainly use C₂₋₈ alkylene glycols. Specific examples include ethylene glycol, 1,3-propylene glycol, 1,4-butanediol, 1,6-hexanediol, 1,4-cyclohexanedimethanol, and the like. Of these, ethylene glycol or 1,4-butanediol is preferred in terms of imparting heat resistance.

As the component constituting the polyester of the hard segment, those comprising a butylene terephthalate unit (a unit comprising terephthalic acid and 1,4-butanediol) or a butylene naphthalate unit (a unit comprising 2,6-naphthalenedicarboxylic acid and 1,4-butanediol) are preferred in terms of physical properties, moldability, and cost performance.

When an aromatic polyester suitable for the polyester that constitutes the hard segment of the polyester elastomer (A) used in the present invention is produced beforehand and then copolymerized with the soft segment component, such an aromatic polyester can be easily prepared in accordance with a typical polyester production method. The polyester preferably has a number average molecular weight of 10000 to 40000.

The soft segment of the polyester elastomer (A) used in the present invention is at least one member selected from aliphatic polyethers, aliphatic polyesters, and aliphatic polycarbonates.

The aliphatic polyethers include poly(ethylene oxide)glycol, poly(propylene oxide)glycol, poly(tetramethylene oxide)glycol, poly(hexamethylene oxide)glycol, poly(trimethylene oxide)glycol, copolymers of ethylene oxide with propylene oxide, ethylene oxide adducts of poly(propylene oxide)glycol, and copolymers of ethylene oxide with tetrahydrofuran. Of these, poly(tetramethylene oxide)glycol and ethylene oxide adducts of poly(propylene oxide)glycol are preferred in terms of elastic characteristics.

The aliphatic polyesters include poly(ε-caprolactone), polyenantholactone, polycaprylolactone, and polybutylene adipate. Of these, poly(ε-caprolactone) and polybutylene adipate are preferred in terms of elastic characteristics.

The aliphatic polycarbonates are preferably those formed mainly from C₂₋₁₂ aliphatic diol residues. Examples of these aliphatic diols include ethylene glycol, 1,3-propylene glycol, 1,4-butanediol, 1,5-pentanediol, 1,6-hexanediol, 1,8-octanediol, 2,2-dimethyl-1,3-propanediol, 3-methyl-1,5-pentanediol, 2,4-diethyl-1,5-pentanediol, 1,9-nonanediol, 2-methyl-1,8-octanediol, and the like. In particular, C₅₋₁₂ aliphatic diols are preferred in terms of the flexibility and low-temperature characteristics of the thermoplastic polyester elastomer to be obtained. These components may be used singly or in a combination of two or more where necessary, with reference to the descriptions below.

Aliphatic polycarbonate diols having excellent low-temperature characteristics for constituting the soft segment of the polyester elastomer usable in the present invention are preferably those having a low melting point (e.g., 70° C. or lower) and a low glass-transition temperature. An aliphatic polycarbonate diol formed from 1,6-hexanediol, which is generally used for forming the soft segment of a polyester elastomer, has a glass-transition temperature of as low as about −60° C., and a melting point of about 50° C., thus exhibiting excellent low-temperature characteristics. In addition, an aliphatic polycarbonate diol obtained by copolymerizing the aliphatic polycarbonate diol with a suitable amount of, for example, 3-methyl-1,5-pentanediol is considered to have excellent low-temperature characteristics due to its decreased melting point or amorphous structure, although the glass-transition point is slightly increased compared with that of the original aliphatic polycarbonate diol. Additionally, for example, an aliphatic polycarbonate diol formed from 1,9-nonanediol and 2-methyl-1,8-octanediol is considered to have excellent low-temperature characteristics because of its sufficiently low melting point of about 30° C. and glass-transition temperature of about −70° C.

The soft segment of the polyester elastomer (A) is preferably an aliphatic polycarbonate diol, in terms of the heat aging resistance of the polyester elastomer resin composition.

An absolute requirement for the polyester elastomer (A) used in the present invention is a Shore D hardness of 55D or less. Accordingly, the mass ratio of the hard segment to the soft segment (hard segment:soft segment) is generally preferably in the range of 10:90 to 75:25, more preferably 15:85 to 70:30, even more preferably 20:80 to 65:35, particularly preferably 40:60 to 65:35, and most preferably 45:55 to 60:40.

In general, thermoplastic polyester elastomers with a larger proportion of the hard segment have better flame retardancy. On the other hand, a larger proportion of the hard segment is synonymous with a high material hardness. If the material hardness is too high, the addition of the flame retardant causes significant reduction in mechanical characteristics and durability. Therefore, the mass ratio of the hard segment to the soft segment in the polyester elastomer is preferably within the above ranges, and a Shore D hardness of 55D or less is an absolute requirement. The Shore D hardness is preferably 53D or less, and more preferably 51D or less. The lower limit of the Shore D hardness is not particularly limited, but is preferably 30D or more.

The reduced viscosity of the polyester elastomer (A) used in the present invention is preferably 1.0 to 2.5 dl/g, and more preferably 1.0 to 2.0 dl/g.

The polyester elastomer (A) used in the present invention may be produced by a known method. For example, any of the following methods may be used: a method in which a lower alcohol diester of a dicarboxylic acid, an excessive amount of a low-molecular-weight glycol, and a soft segment component are subjected to transesterification in the presence of a catalyst, and the obtained reaction product is subjected to polycondensation; a method in which a dicarboxylic acid, an excessive amount of a glycol, and a soft segment component are subjected to esterification in the presence of a catalyst, and the obtained reaction product is subjected to polycondensation; a method in which the polyester of the hard segment is prepared beforehand, and a soft segment component is added to this hard segment to prepare a randomized copolymer by transesterification; a method in which the hard segment and the soft segment are linked with a chain linking agent; and, when poly(ε-caprolactone) is used for the soft segment, a method in which an addition reaction of a ε-caprolactone monomer with the hard segment is performed.

### Phosphorus Flame Retardant (B)

In general, phosphorus flame retardants include organic phosphorus compounds and inorganic phosphorus compounds. The phosphorus flame retardants (B) usable in the present invention are roughly classified into organic phosphorus compounds and inorganic phosphorus compounds. Examples of organic phosphorus compounds include phosphates, phosphonates, phosphinates, and phosphites. Specific examples include trimethyl phosphate, triethyl phosphate, tributyl phosphate, trioctyl phosphate, tributoxyethyl phosphate, octyldiphenyl phosphate, tricresyl phosphate, cresyldiphenyl phosphate, triphenyl phosphate, trixylenyl phosphate, tris-isopropylphenyl phosphate, diethyl-N,N-bis(2-hydroxyethyl)aminomethylphosphonate, bis(1,3-phenylenediphenyl)phosphate, and the like. Of these, in terms of flame retardancy, phosphinic acid metal salts are preferred, and aluminum phosphinate is particularly preferred. Examples of inorganic phosphorus compounds include inorganic phosphate compounds, such as red phosphorus compounds, ammonium (poly)phosphate, melamine (poly)phosphate, and piperazine (poly)phosphate. Some industries have restrictions on organic phosphorus compounds. In that case, the application of inorganic phosphorus compounds is required, and (poly)phosphate compounds are preferable as inorganic phosphorus compounds. Examples of the type of (poly)phosphate compound include condensed phosphates in which monomeric orthophosphates and orthophosphates have become multimers due to the dehydration reaction. Condensed phosphates include pyrophosphates, metaphosphate, polyphosphates, and the like. That is, the (poly)phosphate compound refers to one or two or more members selected from orthophosphate compounds, pyrophosphate compounds, metaphosphate compounds, and polyphosphate compounds. Any of these (poly)phosphate compounds may be used without a problem; however, those with a lower molecular weight are more preferred in terms of exhibiting high flame retardancy, and those with a higher molecular weight are more preferred in terms of suppressing bleeding out of the phosphorus flame retardant and elution during immersion in water. Therefore, among the (poly)phosphate compounds, pyrophosphate compounds are preferred. The (poly)phosphate compound may be a single (poly)phosphate compound, or two or more (poly)phosphate compounds may be contained to form a composite flame retardant. The characteristics (flame retardancy and thermal stability) of (poly)phosphate compounds are derived from the chemical structure of their counterions, and each counterion has its own unique characteristics. For example, ammonium (poly)phosphate has excellent flame retardancy, but has poor processing stability. In contrast, melamine (poly)phosphate has excellent processing stability, but has poor flame retardancy. The use of a composite flame retardant comprising two or more (poly)phosphate compounds can result in a composition with an excellent balance of multiple characteristics, such as flame retardancy and processing stability. In particular, the use of a composite flame retardant comprising melamine (poly)phosphate and piperazine (poly)phosphate as the phosphorus flame retardant (B) is preferable because the resulting composition can have a more excellent balance of flame retardancy and processing stability (i.e., mechanical characteristics). The use of a composite flame retardant comprising melamine pyrophosphate and piperazine pyrophosphate as the phosphorus flame retardant (B) is more preferable.

The phosphorus flame retardant (B) can be a phosphorus flame retardant having an average particle size D50 of 20 μm or less and a phosphorus concentration of 15 mass % or more. Regarding the average particle size D50, if flame retardants with a large particle size are used, the surface smoothness of extruded molded articles tends to deteriorate. Regarding the phosphorus concentration, flame retardants with a low phosphorus concentration tend to be less effective to impart flame retardancy. Thus, a large amount of addition is required, and it is difficult to satisfy both flame retardancy and other characteristics. The average particle size D50 can be measured and analyzed with a laser diffraction particle size analyzer, and the phosphorus concentration can be measured (calculated) by an ICP emission spectroscopic analysis method. The average particle size D50 is preferably 16 μm or less, and more preferably 12 μm or less. The lower limit of the average particle size D50 is not particularly limited, but is preferably 0.1 μm or more. The phosphorus concentration is preferably 18 mass % or more, and more preferably 20 mass % or more. The upper limit of the phosphorus concentration is not particularly limited, but is preferably 30 mass % or less.

The content of the phosphorus flame retardant (B) is 5 to 50 parts by mass, preferably 8 to 40 parts by mass, more preferably 10 to 35 parts by mass, and particularly preferably 15 to 30 parts by mass, based on 100 parts by mass of the polyester elastomer (A). If the content of the phosphorus flame retardant (B) is less than 5 parts by mass, the flame retardancy is insufficient. If the content of the phosphorus flame retardant (B) exceeds 50 parts by mass, there are problems such as lower mechanical characteristics.

Further, the polyester elastomer resin composition of the present invention may contain, if necessary, non-halogen flame retardants other than phosphorus flame retardants. The type of non-halogen flame retardant other than phosphorus flame retardants includes nitrogen flame retardants, silicone flame retardants, metal hydroxides, metal boroxides, and the like.

### Acid End Capping Agent (C)

The acid end capping agent (C) used in the present invention is a compound having a functional group that can react with the terminal carboxyl group of the polyester elastomer (A). Examples of functional groups that can react with the terminal carboxyl group of the polyester elastomer (A) include epoxy groups, hydroxyl groups, carbodiimide groups, oxazoline groups, and the like. Of these, in terms of the melt viscosity change during melt retention and the reactivity with the terminal carboxyl group of the polyester elastomer, the functional group of the acid end capping agent (C) is preferably an epoxy group or a carbodiimide group. Therefore, the acid end capping agent (C) is preferably an epoxy compound (C-1) and/or a carbodiimide compound (C-2). The acid end capping agent (C) is not necessarily mixed, as described later, as long as the acid value of the polyester elastomer resin composition satisfies 10 eq/ton or less. The mixing amount (content) thereof may be 0.

Examples of the epoxy compound (C-1) include aliphatic epoxy compounds, such as ethylene glycol diglycidyl ether, polyethylene glycol diglycidyl ether, propylene glycol diglycidyl ether, polypropylene glycol diglycidyl ether, butanediol diglycidyl ether, neopentyl glycol diglycidyl ether, hexanediol diglycidyl ether, glycerol triglycidyl ether, trimethylolpropane triglycidyl ether, and diglycerol tetraglycidyl ether; alicyclic epoxy compounds, such as dicyclopentadiene dioxide, epoxycyclohexenecarboxylic acid ethylene glycol diester, 3,4-epoxycyclohexenylmethyl-3′-4′-epoxycyclohexene carboxylate, and 1,2:8,9-diepoxylimonene; bisphenol F diepoxy compounds; epoxy compounds obtained by the reaction of polyphenol compounds with epichlorohydrin, and hydrogenated compounds thereof; aromatic or heterocyclic epoxy compounds, such as phthalic acid diglycidyl ester and triglycidyl isocyanurate; compounds having an epoxy group at the end of silicone oil; compounds having alkoxysilane and an epoxy group; and the like.

The epoxy compound (C-1) is preferably a diepoxy compound, in terms of reaction control and imparting extrusion moldability. Monoepoxy compounds have no effect of chain extension and a poor effect of imparting extrusion moldability. Further, many of them have a low volatilization temperature, and gas during molding may cause a problem. In addition, tri- or higher functional epoxy compounds have a large effect of imparting melt viscosity; however, reaction control and fluidity retention may be difficult.

The epoxy compound (C-1) is preferably a bisphenol F diepoxy compound. Bisphenol F epoxy compounds have a superior balance between epoxy equivalent and low volatility compared with other epoxy compounds; thus, while the reactivity with the terminal carboxyl group of the polyester elastomer is maintained, problems such as decomposition gas and associated appearance defects are less likely to occur. Furthermore, compounds that are liquid under ambient temperature and pressure have the advantage that they can easily exhibit flexing fatigue while retaining fluidity, because they exhibit a plasticizing effect simultaneously with an effect of chain extension. These compounds are preferably used. Usable examples of such epoxy compounds include Epiclon 830 produced by DIC Corporation, jER4004P, jER4005P, and jER4010P produced by Mitsubishi Chemical Corporation, and the like.

The content of the epoxy compound (C-1) is 0 to 5 parts by mass based on 100 parts by mass of the polyester elastomer W. When the epoxy compound (C-1) is added to the polyester elastomer (A), the content thereof is preferably 0.1 to 5 parts by mass, and more preferably 0.1 to 3 parts by mass, based on 100 parts by mass of the polyester elastomer W. This component is added for the purpose of improving hydrolysis resistance and also improving flexing fatigue by chain extension. If the content of the epoxy compound (C-1) is less than 0.1 parts by mass, these improvement effects are insufficient. In contrast, if the content of the epoxy compound (C-1) exceeds 5 parts by mass, the flame retardancy may be reduced, and the mechanical characteristics may be reduced due to foreign matter effects.

The carbodiimide compound (C-2) used in the present invention is a compound that has at least one carbodiimide group represented by (—N═C═N—) in the molecule, and that can react with the terminal group of the polyester elastomer.

Examples of the carbodiimide compound (C-2) include diphenylcarbodiimide, di-cyclohexylcarbodiimide, di-2,6-dimethylphenylcarbodiimide, diisopropylcarbodiimide, dioctyldecylcarbodiimide, di-o-toluylcarbodiimide, di-p-toluylcarbodiimide, di-p-nitrophenylcarbodiimide, di-p-aminophenylcarbodiimide, di-p-hydroxyphenylcarbodiimide, di-p-chlorophenylcarbodiimide, di-o-chlorophenylcarbodiimide, di-3,4-dichlorophenylcarbodiimide, di-2,5-dichlorophenylcarbodiimide, p-phenylene-bis-o-toluylcarbodiimide, p-phenylene-bis-dicyclohexylcarbodiimide, p-phenylene-bis-di-p-chlorophenylcarbodiimide, 2,6,2′,6′-tetraisopropyldiphenylcarbodiimide, hexamethylene-bis-cyclohexylcarbodiimide, ethylene-bis-diphenylcarbodiimide, ethylene-bis-di-cyclohexylcarbodiimide, N,N′-di-o-toluylcarbodiimide, N,N′-diphenylcarbodiimide, N,N′-dioctyldecylcarbodiimide, N,N′-di-2,6-dimethylphenylcarbodiimide, N-toluyl-N′-cyclohexylcarbodiimide, N,N′-di-2,6-diisopropylphenylcarbodiimide, N,N′-di-2,6-di-tert-butyphenylcarbodiimide, N-toluyl-N′-phenylcarbodiimide, N,N′-di-p-nitrophenylcarbodiimide, N,N′-di-p-aminophenylcarbodiimide, N,N′-di-p-hydroxyphenylcarbodiimide, N,N′-di-cyclohexylcarbodiimide, N,N′-di-p-toluylcarbodiimide, N,N′-benzylcarbodiimide, N-octadecyl-N′-phenylcarbodiimide, N-benzyl-N′-phenylcarbodiimide, N-octadecyl-N′-toluylcarbodiimide, N-cyclohexyl-N′-toluylcarbodiimide, N-phenyl-N′-toluylcarbodiimide, N-benzyl-N′-toluylcarbodiimide, N,N′-di-o-ethylphenylcarbodiimide, N,N′-di-p-ethylphenylcarbodiimide, N,N′-di-o-isopropylphenylcarbodiimide, N,N′-di-p-isopropylphenylcarbodiimide, N,N′-di-o-isobutylphenylcarbodiimide, N,N′-di-p-isobutylphenylcarbodiimide, N,N′-di-2,6-diethylphenylcarbodiimide, N,N′-di-2-ethyl isopropylphenylcarbodiimide, N,N′-di-2-isobutyl isopropylphenylcarbodiimide, N,N′-di-2,4,6-trimethylphenylcarbodiimide, N,N′-di-2,4,6-triisopropylphenylcarbodiimide, N,N′-di-2,4,6-triisobutylphenylcarbodiimide, and other mono- or dicarbodiimide compounds; poly(1,6-hexamethylenecarbodiimide), poly(4,4′-methylenebiscyclohexylcarbodiimide), poly(1,3-cyclohexylenecarbodiimide), poly(1,4-cyclohexylenecarbodiimide), poly(4,4′-diphenylmethanecarbodiimide), poly(3,3′-dimethyl-4,4′-diphenylmethanecarbodiimide), poly(naphthylenecarbodiimide), poly(p-phenylenecarbodiimide), poly(m-phenylenecarbodiimide), poly(toluylcarbodiimide), poly(diisopropylcarbodiimide), poly(methyl-diisopropylphenylenecarbodiimide), poly(triethylphenylenecarbodiimide), poly(triisopropylphenylenecarbodiimide), and other polycarbodiimides; and the like. Preferred of these are N,N′-di-2,6-diisopropylphenylcarbodiimide, 2,6,2′,6′-tetraisopropyldiphenylcarbodiimide, and polycarbodiimide; more preferred are poly(1,6-hexamethylenecarbodiimide), poly(4,4′-methylenebiscyclohexylcarbodiimide), poly(1,3-cyclohexylenecarbodiimide), poly(1,4-cyclohexylenecarbodiimide), poly(4,4′-diphenylmethanecarbodiimide), poly(3,3′-dimethyl-4,4′-diphenylmethanecarbodiimide), poly(naphthylenecarbodiimide), poly(p-phenylenecarbodiimide), poly(m-phenylenecarbodiimide), poly(toluylcarbodiimide), poly(diisopropylcarbodiimide), poly(methyl-diisopropylphenylenecarbodiimide), poly(triethylphenylenecarbodiimide), poly(triisopropylphenylenecarbodiimide), and other polycarbodiimides; and particularly preferred are poly(1,4-cyclohexylenecarbodiimide) and poly(triisopropylphenylenecarbodiimide).

The content of the carbodiimide compound (C-2) is 0 to 1.5 parts by mass based on 100 parts by mass of the polyester elastomer (A). When the carbodiimide compound (C-2) is added to the polyester elastomer (A), the content thereof is preferably 0.1 to 1.5 parts by mass, more preferably 0.3 to 1.2 parts by mass, and even more preferably 0.5 to 1.0 parts by mass, based on 100 parts by mass of the polyester elastomer (A). If the content of the carbodiimide compound (C-2) is less than 0.1 parts by mass, the hydrolysis resistance may be insufficient, and a larger amount of the flame retardant may cause problems, such as lower tensile elongation. If the content of the carbodiimide compound (C-2) exceeds 1.5 parts by mass, the carbodiimide itself generates a large amount of decomposition gas of isocyanate components etc., which tends to impair the appearance of the extruded molded article.

As the acid end capping agent (C), either the epoxy compound (C-1) or the carbodiimide compound (C-2) may be used. Further, the epoxy compound (C-1) and the carbodiimide compound (C-2) can be used in combination as the acid end capping agent (C). In that case, the upper limit of the content of each compound is divided proportionally depending on the content ratio of the epoxy compound (C-1) and carbodiimide compound (C-2). For example, when the epoxy compound (C-1) and the carbodiimide compound (C-2) are used at a mass ratio of 50:50, the upper limit of the content of the epoxy compound (C-1) may be 2.5 parts by mass, and the upper limit of the content of the carbodiimide compound (C-2) may be 0.75 parts by mass.

### Amide Lubricant (D)

The amide lubricant (D), which is one of the components used in the present invention, is an aliphatic compound having an amide group in its chemical structure, and is added to suppress the amount of gum generated during extrusion molding. Specific examples include aliphatic monoamide compounds, such as oleoyl oleic acid amide, stearyl oleic acid amide, and oleoyl stearic acid amide; aliphatic bisamide compounds, such as methylene bisstearic acid amide, ethylene bisstearic acid amide, methylene bisoleic acid amide, ethylene bisoleic acid amide, methylene bispalmitic acid amide, ethylene bispalmitic acid amide, methylene oleic acid stearic acid diamide, ethylene oleic acid stearic acid diamide, methylene oleic acid palmitic acid diamide, ethylene oleic acid palmitic acid diamide, methylene stearic acid palmitic acid diamide, and ethylene stearic acid palmitic acid diamide; fatty acid amide waxes obtained by reacting mixtures of aliphatic monocarboxylic acids and polybasic acids with diamines; and the like. Such a fatty acid amide wax is obtained by the dehydration reaction of a mixture of an aliphatic monocarboxylic acid and a polybasic acid with a diamine. Preferable aliphatic monocarboxylic acids are saturated aliphatic monocarboxylic acids and hydroxycarboxylic acids, and examples include palmitic acid, stearic acid, behenic acid, montanic acid, 12-hydroxystearic acid, and the like. Examples of polybasic acids, which are dibasic or higher carboxylic acids, include aliphatic dicarboxylic acids, such as malonic acid, succinic acid, adipic acid, sebacic acid, pimelic acid, and azelaic acid; aromatic dicarboxylic acids, such as phthalic acid and terephthalic acid; alicyclic dicarboxylic acids, such as cyclohexanedicarboxylic acid and cyclohexylsuccinic acid; and the like. Examples of diamine compounds include ethylenediamine, 1,3-diaminopropane, 1,4-diaminobutane, hexamethylenediamine, metaxylylenediamine, tolylenediamine, paraxylylenediamine, phenylenediamine, isophoronediamine, and the like. These amide lubricants (D) preferably have a softening temperature at a temperature of 0 to 30° C. higher than the melting point of the polyester elastomer (A) because they are ideally in a molten state only during extrusion molding. If the softening temperature is higher than the processing temperature, the gum prevention effect during extrusion molding is not sufficiently exhibited. If the softening temperature is too low, bleeding out in molded articles tends to be more pronounced.

When the amide lubricant (D), which is an optional component, is contained, the content thereof is preferably 0.1 to 3 parts by mass, more preferably 0.1 to 2 parts by mass, and even more preferably 0.3 to 1 part by mass, based on 100 parts by mass of the polyester elastomer (A).

### Other Additives

The polyester elastomer resin composition of the present invention may contain, if necessary, aromatic amine-based, hindered phenol-based, phosphorus-based, sulfur-based, and other general-purpose antioxidants.

Further, when the polyester elastomer resin composition of the present invention is required to have weather resistance, it is preferable to add an UV absorber and/or a hindered amine-based compound. For example, benzophenone-based, benzotriazole-based, triazole-based, nickel-based, and salicyl-based light stabilizers can be used. Specific examples include 2,2′-dihydroxy-4-methoxybenzophenone, 2-hydroxy-4-n-octoxybenzophenone, p-t-butylphenyl salicylate, 2,4-di-t-butylphenyl-3,5-di-t-butyl-4-hydroxybenzoate, 2-(2′-hydroxy-5′-methylphenyl)benzotriazole, 2-(2′-hydroxy-3′,5′-di-t-amyl-phenyl)benzotriazole, 2-[2′-hydroxy-3′,5′-bis(α,α-dimethylbenzylphenyl)benzotriazole, 2-(2′-hydroxy-3′-t-buty-5′-methylphenyl)-5-chlorobenazotriazole, 2-(2′-hydroxy-3′,5′-di-t-butyphenyl)-5-chlorobenzothiriazole, 2,5-bis-[5′-t-butylbenzoxazolyl-(2)]-thiophene, bis(3,5-di-t-butyl-4-hydroxybenzyl phosphoric acid monoethyl ester) nickel salts, mixtures of 85 to 90% of 2-ethoxy-5-t-buty-2′-ethyloxalic acid-bis-anilide and 10 to 15% of 2-ethoxy-5-t-buty-2′-ethyl-4′-t-butyoxalic acid-bis-anilide, 2-[2-hydroxy-3,5-bis(α,α-dimethylbenzyl)phenyl]-2H-benzotriazole, 2-ethoxy-2′-ethyloxalic acid bisanilide, 2-[2′-hydroxy-5′-methyl-3′-(3″,4″,5″,6″-tetrahydrophthalimide-methyl)phenyl]benzotriazole, bis(5-benzoyl-4-hydroxy-2-methoxyphenyl)methane, 2-(2′-hydroxy-5′-t-octylphenyl)benzotriazole, 2-hydroxy-4-i-octoxybenzophenone, 2-hydroxy-4-dodecyloxybenzophenone, 2-hydroxy octadecyloxybenzophenone, phenyl salicylate, and other light stabilizers. The content is preferably 0.1 mass % or more and 5 mass % or less based on the mass of the polyester elastomer resin composition.

The polyester elastomer resin composition of the present invention may contain various other additives. As additives, resins other than polyester elastomers, inorganic fillers, stabilizers, and anti-aging agents may be added as long as the characteristics of the present invention are not impaired. Further, as other additives, coloring pigments, inorganic and organic fillers, coupling agents, tackiness improvers, quenchers, stabilizers such as metal deactivators, flame retardants, etc. can also be added. In the polyester elastomer resin composition of the present invention, the total of the polyester elastomer (A), the phosphorus flame retardant (B), the acid end capping agent (C), and the amide lubricant (D) (the acid end capping agent (C) and the amide lubricant (D) are optional components) preferably occupies 80 mass % or more, more preferably 90 mass % or more, and even more preferably 95 mass % or more.

### Polyester Elastomer Resin Composition

The acid value of the polyester elastomer resin composition of the present invention is 10 eq/ton or less. The lower limit of the acid value of the polyester elastomer resin composition is not particularly limited, but is preferably 0 eq/ton. The acid value of the polyester elastomer resin composition is preferably 10 eq/ton or less, because there are a few carboxyl terminals that promote the hydrolysis of polyesters, and more excellent hydrolysis resistance can be exhibited.

The polyester elastomer resin composition obtained by the present invention has excellent flame retardancy and mechanical characteristics, and can further retain flexibility, forming processability, heat resistance, chemical resistance, flexing fatigue resistance, abrasion resistance, electrical characteristics, and other characteristics inherent in polyester elastomers. Hence, the composition can be applied to a wide range of parts, such as various parts of electrical products, hoses, tubes, and cable-covering materials. In particular, it is useful to expand the application to cable covering. In addition to these, the polyester elastomer resin composition obtained by the present invention can be shaped into various molded articles by injection molding, extrusion molding, transfer molding, blow molding, or the like.

### EXAMPLES

Examples are provided below to describe the present invention in more detail; however, the present invention is not limited to these Examples. The measurement values in the Examples were measured by the following method.

### Melting Point

Using a differential scanning calorimeter (DSC220, produced by Seiko Instruments Inc.), 5 mg of a measurement sample was placed in an aluminum pan, the lid was pressed for sealing, and the sample was held once at 250° C. for 5 minutes to completely melt the sample. Then, the sample was rapidly cooled with liquid nitrogen, and subjected to measurement from −150° C. to 250° C. at a heating rate of 20° C./min. From the obtained thermogram curve, the endothermic peak temperature was defined as the melting point.

### Reduced Viscosity

0.05 g of a resin was dissolved in 25 ml of a mixed solvent of phenol/tetrachloroethane (mass ratio 60/40), and the solution was subjected to measurement at 30° C. using an Ostwald viscometer.

### Acid Value

The acid value (eq/ton) of the polyester elastomer (A) was determined in such a manner that 200 mg of a fully dried sample (polyester elastomer) was dissolved in 10 mL of hot benzyl alcohol, the obtained solution was cooled, then 10 mL of chloroform and phenol red were added, and the acid value (eq/ton) was determined by a fusion titration method for titration with a 1/25 specified alcoholic potash solution (a methanol solution of KOH). The acid value of the polyester elastomer resin composition was also measured in the same manner.

### Shore D Hardness

According to JIS K6253:2012, the hardness was measured using a Type D Durometer. The numerical value was read 15 seconds after the pressure plate was brought into contact with the test sample.

The components used in the Examples are as follows.

Polyester Elastomer (A)

Polyester Elastomer A-1

100 parts by mass of an aliphatic polycarbonate diol (carbonate diol UH-CARB200, produced by UBE Corporation; molecular weight: 2000, 1,6-hexanediol type) and 8.6 parts by mass of diphenyl carbonate were placed and reacted at a temperature of 205° C. at 130 Pa. After 2 hours, the content was cooled to obtain an aliphatic polycarbonate diol (number average molecular weight: 10000). 43 parts by mass of the aliphatic polycarbonate diol (PCD) and 57 parts by mass of polybutylene terephthalate (PBT) having a number average molecular weight of 30000 were stirred at 230° C. to 245° C. at 130 Pa for 1 hour. After it was confirmed that the resin became transparent, the content was taken out and cooled to produce a polyester elastomer. The melting point of the polyester elastomer (A-1) was 207° C., the reduced viscosity was 1.21 dl/g, and the acid value was 44 eq/ton.

Polyester Elastomer A-2

100 parts by mass of an aliphatic polycarbonate diol (carbonate diol UH-CARB200, produced by UBE Corporation; molecular weight: 2000, 1,6-hexanediol type) and 8.6 parts by mass of diphenyl carbonate were placed and reacted at a temperature of 205° C. at 130 Pa. After 1 hour, the content was cooled to obtain an aliphatic polycarbonate diol (number average molecular weight: 5000). 43 parts by mass of the aliphatic polycarbonate diol (PCD) and 57 parts by mass of polybutylene terephthalate (PBT) having a number average molecular weight 30000 were stirred at 230° C. to 245° C. at 130 Pa for 1 hour. After it was confirmed that the resin became transparent, the content was taken out. The pellets taken out were heated at 170 to 180° C., and solid-phase polycondensation was performed to produce a polyester elastomer. The melting point of the polyester elastomer (A-2) was 208° C., the reduced viscosity was 1.21 dl/g, and the acid value was 7 eq/ton.

Polyester Elastomer A-3

Terephthalic acid, 1,4-butanediol, and poly(tetramethylene oxide)glycol (PTMG; number average molecular weight: 1000) were used as constituents to produce a polyester elastomer in which the ratio of the hard segment (polybutylene terephthalate) to the soft segment (PTMG) was 64/36 (mass %). The melting point of the polyester elastomer (A-3) was 203° C., the reduced viscosity was 1.75 dl/g, and the acid value was 50 eq/ton.

Polyester Elastomer A-4

100 parts by mass of an aliphatic polycarbonate diol (carbonate diol UH-CARB200, produced by UBE Corporation; molecular weight: 2000, 1,6-hexanediol type) and 8.6 parts by mass of diphenyl carbonate were placed and reacted at a temperature of 205° C. at 130 Pa. After 2 hours, the content was cooled to obtain an aliphatic polycarbonate diol (number average molecular weight: 10000). 30 parts by mass of the aliphatic polycarbonate diol (PCD) and 70 parts by mass of polybutylene terephthalate (PBT) having a number average molecular weight of 30000 were stirred at 230° C. to 245° C. at 130 Pa for 1 hour. After it was confirmed that the resin became transparent, the content was taken out and cooled to produce a polyester elastomer. The melting point of the polyester elastomer (A-4) was 212° C., the reduced viscosity was 1.20 dl/g, and the acid value was 41 eq/ton.

Table 1 shows the physical property values of the polyester elastomers.

TABLE 1

| | | | | Physical properties | | | |
|---|---|---|---|---|---|---|---|
| | | | | Acid | Reduced | Shore D | Melting |
| | Formulation (mass %) | | | value | viscosity | hardness | point |
| Abbr. | PBT | PTMG | PCD | (eq/t) | (dl/g) | (D) | (° C.) |
| A-1 | 57 | | 43 | 44 | 1.21 | 50 | 207 |
| A-2 | 57 | | 43 | 7 | 1.21 | 50 | 208 |
| A-3 | 64 | 36 | | 50 | 1.75 | 52 | 203 |
| A-4 | 70 | | 30 | 41 | 1.20 | 60 | 212 |

PBT: polybutylene terephthalate
PTMG: poly(tetramethylene oxide)glycol
PCD: aliphatic polycarbonate diol

### Phosphorus Flame Retardant (B)

(B-1) ADK STAB FP-2200S (a melamine pyrophosphate/piperazine pyrophosphate composite flame retardant, D50: 10 μm, phosphorus concentration: 19 mass %, produced by ADEKA Corporation)

(B-2) EXOLIT OP930 (aluminum diethyl phosphinate, D50: 4 μm, phosphorus concentration: 23 mass %, produced by Clariant)

(B-3) EXOLIT OP1230 (aluminum diethyl phosphinate, D50: 30 μm, phosphorus concentration: 23 mass %, produced by Clariant)

(B-4) BUDIT 3141 (melamine polyphosphate, D50: 8 μm, phosphorus concentration: 10 mass %, produced by Budenheim Chemical Factory)

The average particle size D50 is a value measured by a laser diffraction particle size analyzer, and the phosphorus concentration is a value measured (calculated) by an ICP emission spectroscopic analysis method.

### Acid End Capping Agent (C)

(C-1) Carbodilite HMV-15CA (alicyclic polycarbodiimide, produced by Nisshinbo Chemical Inc.)

(C-2) Epiclon 830 (a bisphenol F diepoxy compound, produced by DIC Corporation)

### Amide Lubricant (D)

(D-1) Light Amide WH-215 (softening temperature: 215° C., produced by Kyoeisha Chemical Co., Ltd.)

### Examples 1 to 7 and Comparative Examples 1 to 7

Based on 100 parts by mass of the polyester elastomer (A), the phosphorus flame retardant (B), the acid end capping agent (C), and the amide lubricant (D) were kneaded and pelletized with a twin-screw extruder at the ratio shown in Table 2. The resulting polyester elastomer resin composition pellets were used to perform the following evaluations. Table 2 shows the results.

### Tensile Strength at Break and Tensile Elongation at Break

The tensile strength and elongation at break of the compositions was measured according to JIS K6251:2010. A test sample was produced by injection-molding the resin composition dried under reduced pressure at 100° C. for 8 hours into a flat plate (100 mm×100 mm×2 mm) using an injection molding machine (model-SAV, produced by Sanjo Seiki Co., Ltd.) at a cylinder temperature (Tm+20° C.) and a mold temperature of 30° C., and then punching a dumbbell-shaped No. 3 test sample from the flat plate.

### Heat-Resistant and Water-Resistant Treatments: Heat-Resistant and Water-Resistant Elongation Half-Life

The dumbbell-shaped No. 3 test sample was left for a predetermined period of time in an air environment at 140° C. or 170° C., and in a boiling water environment at 100° C., and then taken out, and the tensile elongation at break was measured according to JIS K6251:2010 in the same manner as described above. The tensile elongation at break retention rate was calculated by the following formula, and the time when the value was 50% (tensile elongation half-life) was used as an index for heat resistance and water resistance. The initial tensile elongation at break is tensile elongation at break before the heat-resistant and water-resistant treatments.

Tensile elongation at break retention rate (%)=tensile elongation at break after each treatment/initial tensile elongation at break×100

### Extruded Molded Article Appearance

The pellets melt-kneaded with a twin-screw extruder were extruded again from a T-die with a single-screw extruder to produce a 0.2-mm-thick sheet molded article. The appearance of the extruded molded article was evaluated from the sheet appearance according to the following criteria.

A: There was no roughness or foaming, and the sheet appearance and surface smoothness were good.

B: As with A, the sheet appearance and surface smoothness were good, and the amount of die deposits was significantly small.

C: The sheet appearance was not good due to sheet unevenness and foaming caused by the flame retardant.

### Limiting Oxygen Index LOI

The limiting oxygen index was measured according to JIS K7201-2. The limiting oxygen index is the maximum oxygen concentration that satisfies a combustion time of 180 seconds or less and a combustion distance of 50 mm or less, which are the measurement standards of the oxygen index.

TABLE 2

| | | | | | | | | | | Comp |
|---|---|---|---|---|---|---|---|---|---|---|
| | | | Ex1 | Ex2 | Ex3 | Ex4 | Ex5 | Ex6 | Ex7 | Ex1 |
| Mixing | Polyester | A-1 | 100 | 100 | | 100 | 100 | | | |
| formulation | elastomer | A-2 | | | 100 | | | | | |
| parts by mass | | A-3 | | | | | | 100 | 100 | |
| | | A-4 | | | | | | | | 100 |
| | Phosphorus flame | B-1 | 20 | 20 | 20 | | | | | |
| | retardant | B-2 | | | | 20 | 30 | 10 | 20 | 20 |
| | | B-3 | | | | | | | | |
| | | B-4 | | | | | | | | |
| | Acid end | C-1 | 1.0 | 1.0 | | | | | | |
| | capping agent | C-2 | | | | 3.0 | 3.0 | 3.0 | 3.0 | 3.0 |
| | Amide lubricant | D-1 | | 0.5 | | | | | | |
| Characteristics | Acid value | eq/t | 9 | 9 | 7 | 1 | 2 | 6 | 6 | 2 |
| | (Initial) tensile | MPa | 25 | 24 | 23 | 18 | 15 | 25 | 21 | 21 |
| | strength at break | | | | | | | | | |
| | (Initial) tensile | % | 390 | 400 | 450 | 560 | 480 | 580 | 560 | 410 |
| | elongation at break | | | | | | | | | |
| | Extruded molded article | — | A | B | A | A | A | A | A | A |
| | appearance | | | | | | | | | |
| | Limiting oxygen index | % | 31.0 | 33.5 | 32.0 | 41.0 | 45.0 | 26.5 | 29.0 | 42.0 |
| | LOI | | | | | | | | | |
| | 140° C. heat-resistant | hr | >3000 | >3000 | >3000 | >3000 | >3000 | 350 | 300 | — |
| | elongation half-life | | | | | | | | | |
| | 170° C. heat-resistant | hr | 1700 | 1700 | 1600 | 1800 | 1600 | <50 | <50 | <100 |
| | elongation half-life | | | | | | | | | |
| | 100° C. water-resistant | hr | 500 | 500 | 525 | 800 | 750 | 450 | 400 | <100 |
| | elongation half-life | | | | | | | | | |

| | | | Comp | Comp | Comp | Comp | Comp | Comp |
|---|---|---|---|---|---|---|---|---|
| | | | Ex 2 | Ex 3 | Ex4 | Ex5 | Ex6 | Ex7 |
| Mixing | Polyester | A-1 | 100 | 100 | 100 | 100 | 100 | 100 |
| formulation | elastomer | A-2 | | | | | | |
| parts by mass | | A-3 | | | | | | |
| | | A-4 | | | | | | |
| | Phosphorus flame | B-1 | | | | 20 | | |
| | retardant | B-2 | | 60 | | | 20 | |
| | | B-3 | | | 20 | | | |
| | | B-4 | | | | | | 20 |
| | Acid end | C-1 | | | | 2.0 | | |
| | capping agent | C-2 | 3.0 | 3.0 | 3.0 | | 0.5 | 3.0 |
| | Amide lubricant | D-1 | | | | | | |
| Characteristics | Acid value | eq/t | 2 | 2 | 2 | 1 | 20 | 3 |
| | (Initial) tensile | MPa | 30 | 13 | 18 | 26 | 19 | 19 |
| | strength at break | | | | | | | |
| | (Initial) tensile | % | 600 | 50 | 510 | 400 | 490 | 490 |
| | elongation at break | | | | | | | |
| | Extruded molded article | — | B | C | C | C | A | A |
| | appearance | | | (uneven) | (uneven) | (foamed) | | |
| | Limiting oxygen index | % | 18.0 | 51.0 | 41.0 | 41.0 | 40.5 | 24.5 |
| | LOI | | | | | | | |
| | 140° C. heat-resistant | hr | — | — | >3000 | >3000 | >3000 | >3000 |
| | elongation half-life | | | | | | | |
| | 170° C. heat-resistant | hr | >1000 | — | 1800 | 1800 | 1300 | 1600 |
| | elongation half-life | | | | | | | |
| | 100° C. water-resistant | hr | 1500 | — | 800 | 600 | 200 | 600 |
| | elongation half-life | | | | | | | |

As is clear from the results in Table 2, the polyester elastomer resin compositions of the present invention obtained by mixing a polyester elastomer with a phosphorus flame retardant, an acid end capping agent, and an amide lubricant shown in Examples 1 to 7 have excellent mechanical characteristics, heat aging resistance, and water resistance, and also show high flame retardancy with a limiting oxygen index of 26% or more. Further, the appearance of the extruded molded articles shows good results in all the Examples. In particular, comparison between Example 2 and the other Examples indicates that the addition of the amide lubricant (D) is effective to further improve extrusion moldability. Comparison between Examples 1 to 5 and Examples 6 and 7 indicates that Examples 1 to 5, in which the soft segment is composed of a polycarbonate diol, tend to exhibit higher flame retardancy as well as heat resistance and water resistance, compared with Examples 6 and 7, in which the soft segment is PTMG. On the other hand, in the compositions of Comparative Examples 1 to 7, which do not satisfy the requirements of the present invention, any of the tensile elongation at break, extruded molded article appearance, flame retardancy, heat resistance, and water resistance is inferior in comparison with the compositions of the present invention.

In Comparative Example 1, which uses a polyester elastomer with high surface hardness, the mechanical characteristics are significantly reduced due to the heat-resistant and water-resistant treatments; consequently, the heat resistance and water resistance are inferior. In Comparative Example 2, which does not contain a phosphorus flame retardant, not surprisingly, the limiting oxygen index LOI is less than 26%, and the flame retardancy is inferior. In contrast to Comparative Example 2, in Comparative Example 3, which contains an excess amount of phosphorus flame retardant, the limiting oxygen index LOI shows a high value, whereas the tensile elongation at break (mechanical characteristics) and extruded molded article appearance are inferior. Since the tensile elongation at break was insufficient at the beginning, the evaluation of heat resistance and water resistance based on the elongation half-life was considered inappropriate, and the measurement was not performed. In Comparative Example 4, which uses a phosphorus flame retardant with a large particle size D50, the mechanical characteristics, flame retardancy, heat resistance, and water resistance are excellent, whereas the extruded molded article has remarkable unevenness, and the extrusion moldability is inferior. In Comparative Example 5, which contains an excess amount of carbodiimide compound as an acid end capping agent, the mechanical characteristics, flame retardancy, heat resistance, and water resistance are excellent, whereas the extruded molded article shows foaming behavior, and the extrusion moldability is inferior. In contrast to Comparative Example 5, in Comparative Example 6, which contains a smaller amount of acid end capping agent and shows a high terminal acid value, the water resistance is inferior. In Comparative Example 7, which uses a phosphorus flame retardant with a low phosphorus concentration, the flame retardancy is inferior.

### INDUSTRIAL APPLICABILITY

Thus, the flame-retardant polyester elastomer resin compositions of the present invention have excellent extrusion moldability and surface smoothness even in a thin shape, while maintaining mechanical characteristics, and are halogen-free and have excellent flame retardancy as well as heat aging resistance and hydrolysis resistance. Hence, they can be applied to a wide range of parts, such as various parts of electrical products, hoses, tubes, and cable-covering materials. In addition to these, the resin compositions obtained by the present invention can be shaped into various molded articles by injection molding, extrusion molding, transfer molding, blow molding, or the like.

1. A polyester elastomer resin composition comprising a polyester elastomer (A) and a phosphorus flame retardant (B);
the polyester elastomer (A) comprising a hard segment and a soft segment and having a Shore D surface hardness of 55 or less, wherein the hard segment is composed of a polyester comprising an aromatic dicarboxylic acid and an aliphatic or alicyclic diol as constituents, and the soft segment is at least one member selected from aliphatic polyethers, aliphatic polyesters, and aliphatic polycarbonates;
the phosphorus flame retardant (B) having an average particle size D50 of 20 μm or less and a phosphorus concentration of 15 mass % or more; and
the polyester elastomer resin composition comprising 5 to 50 parts by mass of the phosphorus flame retardant (B) and further, as an acid end capping agent (C), 0 to 5 parts by mass of an epoxy compound (C-1) or 0 to 1.5 parts by mass of a carbodiimide compound (C-2), based on 100 parts by mass of the polyester elastomer (A), and having an acid value of 10 eq/ton or less.

2. The polyester elastomer resin composition according to claim 1, wherein the hard segment of the polyester elastomer (A) is a polyester comprising terephthalic acid and 1,4-butanediol as constituents, the soft segment is an aliphatic polycarbonate diol, and the polyester elastomer (A) has a melting point of 150 to 230° C.

3. The polyester elastomer resin composition according to claim 1, wherein the phosphorus flame retardant (B) is a phosphinic acid metal salt, (poly)phosphate, or both of them.

4. The polyester elastomer resin composition according to claim 1, further comprising 0.1 to 3 parts by mass of an amide lubricant (D) based on 100 parts by mass of the polyester elastomer (A).

5. The polyester elastomer resin composition according to claim 1, for use in cable covering.
